(19) United States
(12) Patent Application Publication
(10) Pub. No.: US 2007/0127647 A1
(43) Pub. Date: Jun. 7, 2007

(54) Methods, systems, and computer program products for collecting messages associated with providing prepaid communications services in a communications network

(75) Inventor: Travis E. Russell, Clayton, NC (US)

Correspondence Address: JENKINS, WILSON, TAYLOR & HUNT, P. A., 3100 TOWER BLVD, SUITE 1200, DURHAM, NC, 27707, US

(73) Assignee: Tekelec

(21) Appl. No.: 11/586,488

(22) Filed: Oct. 25, 2006

Related U.S. Application Data
(60) Provisional application No. 60/729,996, filed on Oct. 25, 2005.

(51) Int. Cl. H04M 15/00

(52) U.S. Cl. 379/114.2

(57) ABSTRACT

Methods, systems, and computer program products for collecting messages associated with providing prepaid communications services in a communications network are disclosed. According to one aspect, a method includes receiving at least a portion of messages copied from a communications network. The at least a portion of messages associated with prepaid calls to a common destination may be identified. At least one measure indicative of an absolute or relative number of prepaid calls being made to the common destination may be generated based on the identified at least a portion of messages.

### RELATED APPLICATION

This non-provisional patent application claims the benefit of U.S. Provisional Application No. 60/729,996, filed Oct. 25, 2005, the disclosure of which is incorporated by reference herein in its entirety.

### TECHNICAL FIELD

The subject matter disclosed herein relates generally to prepaid communications services. More particularly, the subject matter disclosed herein relates to collecting messages associated with prepaid communications services.

### BACKGROUND

Subscribers to one telecommunications service provider often purchase services made available by other telecommunications service providers. One example of such services is prepaid calling card services. Utilizing prepaid calling card services, a caller may purchase a prepaid calling card for establishing a long distance call. A call using the prepaid service may originate from a communications network to which the subscriber has a subscription.

In order to initiate prepaid services, a subscriber is typically required to first dial a prepaid service provider telephone number. Next, the subscriber may be required to enter a personal identification number (PIN) to be validated by a prepaid service platform. After the PIN is validated, the subscriber may then dial a long distance telephone number for the party that the subscriber wishes to call. Next, the prepaid service platform can set up a call between the subscriber and the party corresponding to the dialed telephone number.

Prepaid service is typically provided by an operator that is different than the network operator providing network telephone service to the subscriber. For example, the subscriber may be utilizing a mobile telephone subscribed to a mobile telephone service maintained by a network operator that is different than the prepaid services operator. It would be advantageous for the network operator to know where prepaid calls originating within its network are terminating. For example, if the network operator was able to determine that a significant number of prepaid calls originating in the network were terminating in a particular geographic location, such as Mexico, the network operator may offer reduced calling rate plans to that particular geographic location. In this way, the network operator may be able to gain back customers being serviced by the prepaid service operator. It may also be advantageous for the network operator to know the identity of the prepaid service operator providing prepaid services in its network.

Accordingly, there exists a need for methods, systems, and computer program products for collecting messages associated with providing prepaid communications services in a communications network.

### SUMMARY

According to one aspect, the subject matter described herein comprises methods, systems, and computer program products for collecting messages associated with providing prepaid communications services in a communications network. One method includes receiving at least a portion of messages copied from a communications network. The at least a portion of messages associated with prepaid calls to a common destination may be identified. At least one measure indicative of an absolute or relative number of prepaid calls being made to the common destination may be generated based on the identified at least a portion of messages.

The subject matter described herein providing collecting messages associated with a prepaid communications service may be implemented using a computer program product comprising computer executable instructions embodied in a computer readable medium. Exemplary computer readable media suitable for implementing the subject matter described herein includes disk memory devices, programmable logic devices, application specific integrated circuits, and downloadable electrical signals. In addition, a computer readable medium that implements the subject matter described herein may be distributed across multiple physical devices and/or computing platforms.

### BRIEF DESCRIPTION OF THE DRAWINGS

Exemplary embodiments of the subject matter will now be explained with reference to the accompanying drawings, of which:

FIG. 1 is a block diagram of an exemplary communications network in which prepaid service messages between a mobile terminal and a prepaid service platform are collected according to an embodiment of the subject matter described herein;

FIG. 2 is a flow chart illustrating an exemplary process for collecting messages associated with providing prepaid communications services in the communications network shown in FIG. 1 according to the subject matter described herein;

FIG. 3 is an exemplary IP network in which prepaid communications service messages between a personal computer and a voice over IP (VoIP) calling service platform are collected according to an embodiment of the subject matter described herein;

FIG. 4 is a block diagram of an exemplary prepaid communications services monitoring system architecture according to an embodiment of the subject matter described herein;

FIG. 5 is a block diagram of a monitoring system architecture that collects signaling information from either discrete communication link probes or from an integrated signal transfer point/signaling gateway message copying interface according to an embodiment of the subject matter described herein; and

FIG. 6 is a block diagram of an exemplary system architecture for collecting messages associated with providing prepaid communications services in a communications network according to an embodiment of the subject matter described herein.

### DETAILED DESCRIPTION

The subject matter described herein includes methods, systems, and computer program products for collecting messages associated with providing prepaid communications services in a communications network. According to one embodiment, the subject matter described herein can be utilized for collecting messages associated with prepaid calling services in a communications network. Collected messages may include identification of the called party and identification of a prepaid service provider in a prepaid calling transaction. Collected information may be organized in a report and forwarded to a monitoring entity. The monitoring entity may be the operator of the network in which the prepaid calling service transaction originated. In this way, the network operator may be able to use the information to strategize ways for gaining back customers being serviced by the prepaid service provider. Further, the information may identify the prepaid service operator providing the prepaid services. The information may also be used to generate measures of prepaid calls being made to a common destination.

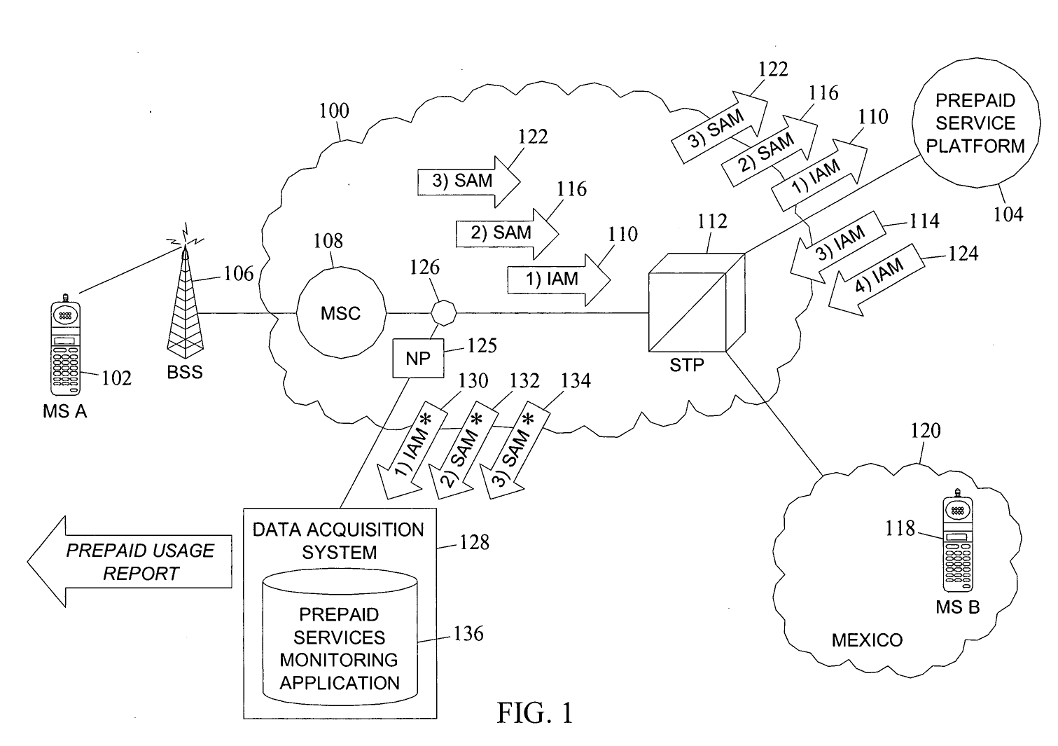

FIG. 1 illustrates a block diagram of an exemplary communications network 100 in which prepaid service messages between a mobile terminal 102 and a prepaid service platform 104 are collected according to an embodiment of the subject matter described herein. In this example, mobile terminal 102 is subscribed to and serviced by network 100. Further, prepaid calling service is provided by a prepaid service provider operating platform 104. Referring to FIG. 1, an operator of mobile terminal 102 utilizes a prepaid calling card to access the prepaid calling services provided by platform 104. The prepaid calling card may identify a toll free 800 number or a premium rate service (PRS) number for connecting to prepaid service platform 104. The prepaid calling card may also identify a personal identification number (PIN) which may be entered and communicated to platform 104 for use in validating the card.

The prepaid calling service may be initiated when the operator of mobile terminal 102 dials the toll free 800 number identified on the prepaid calling card. The number may be used to access platform 104. The digits of the dialed 800 number are transmitted to a base station system (BSS) 106 which routes the digits of the dialed 800 number to a mobile switching center (MSC) 108. MSC 108 may generate a signaling system 7 (SS7) initial address message (IAM) 110 including the dialed number and route IAM 110 to platform 104 via a signal transfer point (STP) 112. In response to receiving IAM 110, platform 104 transmits an SS7 IAM 114 for establishing an initial bearer/voice connection between mobile terminal 102 and platform 104.

Once the connection is established, platform 104 may request the subscriber's PIN for validating prepaid calling services. Next, the operator of mobile terminal 102 may enter the PIN provided on the prepaid calling card. The digits of the PIN are transmitted to BSS 106 which routes the digits to MSC 108. MSC 108 may generate an SS7 subsequent address message (SAM) 116 including the dialed PIN, and route SAM 116 to platform 104 via STP 112. Platform 104 may receive SAM 116 containing the PIN and determine whether the prepaid calling services should be provided to the caller.

In response to determining that prepaid calling services should be provided to the caller, platform 104 requests input of a called party number with which the operator would like a connection to be established. In this example, the operator enters a called party number for establishing a connection with mobile terminal 118 operating in a network 120 located in Mexico. The operator of mobile terminal 102 may dial the called party number, and the dialed called party number is routed to MSC 108. MSC 108 may generate and route another SAM 122 including the entered called party number to platform 104. Once platform 104 receives SAM 122 containing the called party number, platform 104 may generate and transmit an IAM 124 for setting up bearer channels for establishing a call between mobile terminal 102 and mobile terminal 118. Thus, this exemplary call setup is provided by the prepaid calling service associated with platform 104.

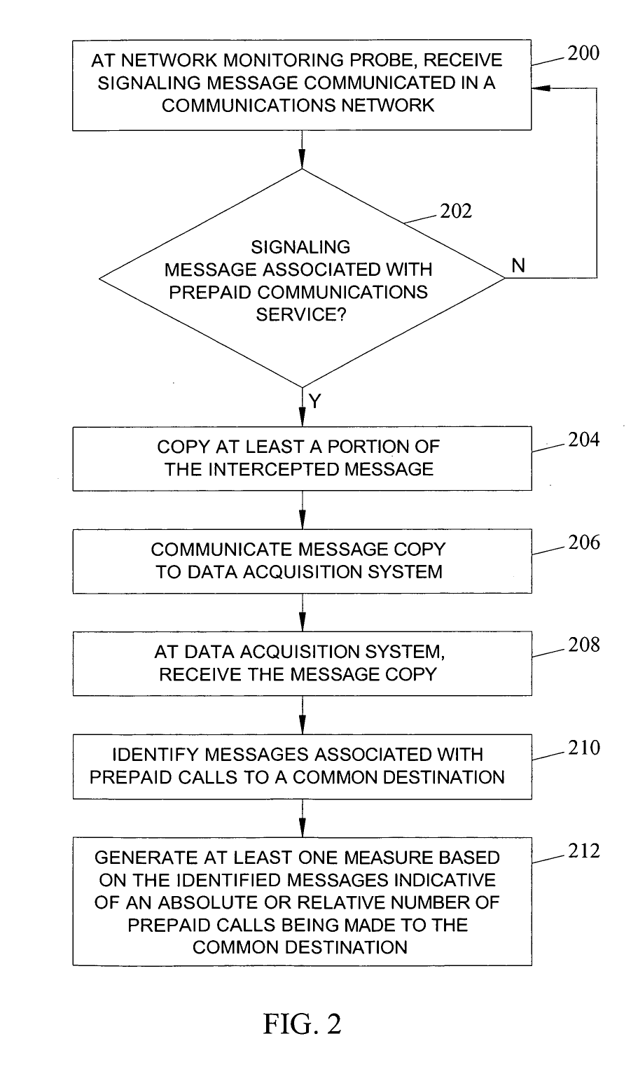

FIG. 2 is a flow chart illustrating an exemplary process for collecting messages associated with providing prepaid communications services in communications network 100 shown in FIG. 1 according to the subject matter described herein. In this example, a network monitoring probe 125 is connected to communications network 100 at a point 126 for intercepting SS7 signaling messages. By connecting at point 126, probe 125 may intercept SS7 signaling messages communicated between MSC 108 and STP 112. Probe 125 may be implemented in an SS7 node, such as an STP or SS7/Internet protocol (IP) router. Alternatively, a link monitor, a routing node, or other suitable network device operable to intercept signaling messages may be connected to communications network 100 at point 126 for interception of SS7 signaling messages in accordance with the subject matter described herein. Point 126 may be a connection point of an SS7 signaling link 127 between MSC 108 and STP 112.

Referring to FIGS. 1 and 2, a SS7 signaling message communicated on a communication link between MSC 108 and STP 112 are received or intercepted by probe 125 at point 126 (block 200). The signaling message may be associated with the provision of prepaid communications services in communications network 100. For example, probe 125 may intercept IAM 110 and SAMs 116 and 122 that are communicated between MSC 108 and STP 112. As stated above, IAM 110 and SAMs 116 and 122 are associated with the provision of prepaid communications service to mobile terminal 102 by the prepaid calling service operating prepaid service platform 104. Mobile terminal 102 has a subscription to communications network 100.

Next, at block 202 of FIG. 2, probe 125 may determine whether the intercepted signaling message is associated with a prepaid communications service. If it is determined that the intercepted message is not associated with a prepaid communications service, the process returns to block 200 to await receipt of another signaling message. In this instance, the intercepted message not associated with a prepaid communications service is effectively ignored by probe 125 and passed along the link to the message's destination.

Otherwise, if it is determined at block 202 that the intercepted message is associated with a prepaid service transaction, a portion of the signaling message or the entire signaling message may be copied (block 204). The message copy is communicated to a data acquisition system 128 (block 206). For example, IAM 110 and SAM 116 may be identified as being associated with a prepaid service transaction and copied. Copies 130, 132, and 134 of IAM 110, SAM 116, and SAM 122, respectively, may then be communicated to system 128.

A signaling message may be identified as being associated with a prepaid communications service based on the message's content. For example, probe 125 may observe signaling message content such as a source address, destination address, a calling party number, and a called party number for determining whether the message is associated with prepaid communications service. Further, the dialed number, such as the 800 number or PRS number, for accessing the prepaid service provider can identify a message as being associated with a prepaid communications service provider. A message having an address with an SS7 point code or IP address identifying a prepaid communications service provider may be copied. For example, a probe may copy each SS7 IAM or SS7 SAM with a destination or source address to a prepaid communications service provider. For example, the 800 number contained in IAM 110 may identify the message as being associated with a prepaid communications service provided by platform 104. Further, for example, the destination address of platform 104 in SAMs 116 and 122 may identify these messages as being associated with communications service provided by platform 104.

Information copied from a message associated with a prepaid service transaction may include a calling party number, a called party number, an originating switching office identifier, time or date of the communication, a prepaid service provider identifier, and subsequent dialed digit information. In addition, copied information may include mobile station ISDN number (MSISDN), mobile identification number (MIN), international mobile station identifier (IMSI), a directory number, a session initiation protocol (SIP) uniform resource identifier (URI), and/or an IP address. The time or date of the communication of a signaling message may be determined by using a time/date stamping function for associating the signaling message with its time or date of receipt. The origination switching office identifier may include an end office (EO) identifier, an MSC identifier, and SIP proxy identifier. A prepaid service provider identifier may include a uniform resource locator (URL), URI, an IP address, an SS7 point code address, a toll free number, and a PRS number. This information may be used for generating a measure based on the identified messages. The measure may be indicative of an absolute or relative number of prepaid calls being made to the common destination.

Further, for example, additional dialed digit information entered by a subscriber via interactions with a prepaid services application, such as an interactive voice response (IVR) application, may be obtained from one or more intercepted SAMs associated with the prepaid service transaction. For example, with regard to additional dialed digit information, a subscriber may dial a toll free number associated with a prepaid service provider. One or more IAMs may be employed to establish a voice/bearer path between the subscriber and an IVR application associated with the prepaid service provider. The IVR may prompt the subscriber to enter the telephone number of the party with which the subscriber wishes to call. As the subscriber enters the called party number into a terminal, the entered digits are communicated via one or more SAMs to the prepaid service provider's IVR application. The prepaid service provider's IVR application can use this information to complete the subscriber's call to the desired called party. This information may be copied from a signaling message and provided to the data acquisition system.

At block 208, data acquisition system 128 may receive the message copy. A prepaid service monitoring application 136 of system 128 may be applied to the data contained in copies 130 and 132 for analyzing and reporting prepaid communications services to a monitoring entity, such as the operator of network 100. In particular, application 136 may identify copied messages that are associated with prepaid calls to a common destination (block 210). For example, called party numbers contained in copied messages may indicate that calls associated with prepaid communications services are being made to a common destination, such as within network 120 in Mexico. An area code portion of a called party number may indicate the destination of a call. Further, application 136 may generate at least one measure based on the identified messages indicative of an absolute or relative number of prepaid calls being made to the common destination (block 212).

Further, the prepaid communications service information may be used to generate individual transaction detail records (TDRs) for each call associated with a prepaid service provider. Exemplary TDR information may include date, time, calling party ID, prepaid service provider ID, any additional collected/dialed digits, and an originating switching office ID.

Data in the message copies may also be used to determine whether a calling party is a subscriber that is “owned” or “serviced by” the operator of the network being monitored. Subscriber information may be useful, for example, in a wireless network environment. The network operator may be interested in knowing the prepaid calling service behavior of only the mobile subscribers operating in the network operator's network. Prepaid calling service behavior of mobile subscribers that are roaming in the network operator's network may be of no interest. The obtained information may also be applied to wireless network environments.

Data relating to prepaid service transaction may be useful to an operator of network 100, for example, for analyzing marketing trends. The information may be reported in a manner that a network operator may be able to determine prepaid calling usage patterns, tendencies, and preferences among its subscribers. For example, if the network operator was able to determine that 40% of all prepaid calls originating from network 100 were terminating in Mexico, the network operator may decide to offer reduced calling rate plans to Mexican destinations in order to gain customers from the prepaid service provider.

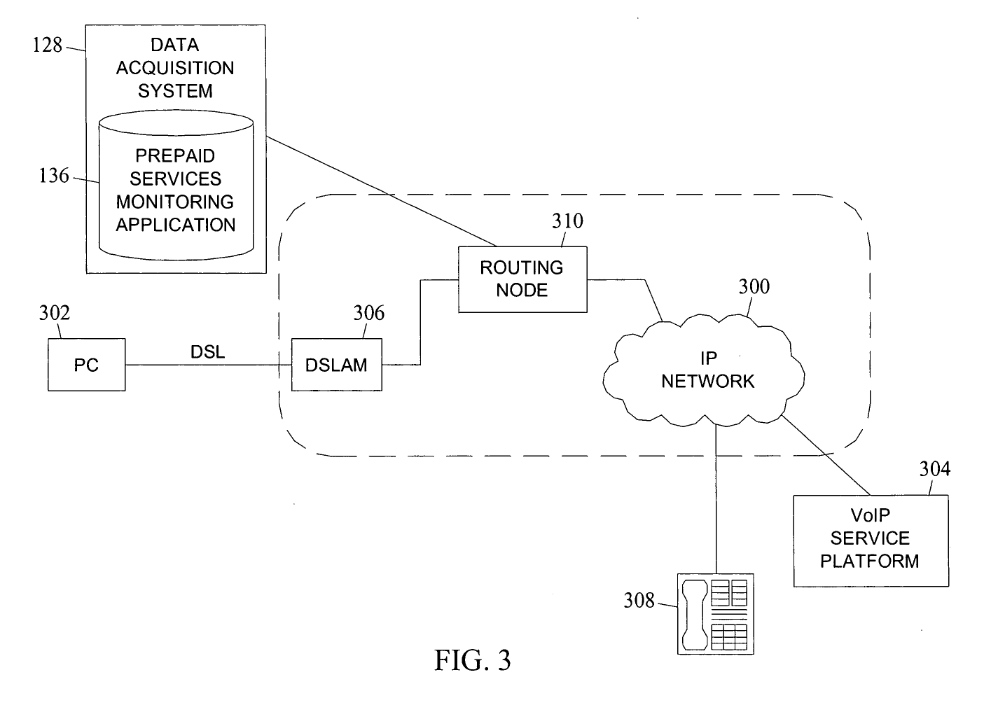

FIG. 3 illustrates an exemplary IP network 300 in which prepaid communications service messages between a personal computer (PC) 302 and a VoIP calling service platform 304 are collected according to an embodiment of the subject matter described herein. In this example, PC 302 is provided Internet services by an operator of IP network 300. Further, PC 302 is provided calling services by an operator of VoIP service platform 304. PC 302 is provided connection to IP network 300 via a digital subscriber line access multiplexer (DSLAM) 306.

Referring to FIG. 3, when a call is initiated from PC 302, a SIP message, such as a SIP INVITE message or a SIP INFO message, may be generated and communicated to VoIP service platform 304 for establishing a call with a called party, such as a SIP telephone 308. The message may be transmitted over IP network 300 using any suitable protocol such as transmission control protocol (TCP), user datagram protocol (UDP), and stream control transmission protocol (SCTP). The message may include identification information of the PC initiating the call, identification information of the VoIP service platform establishing the call, or user-input dialed digit information. Identification information includes a SIP URI, an IP address, a URL, and a URI. For example, an IP address and URL may identify PC 302 and VoIP service platform 304, respectively.

Messages communicated between PC 302 and VoIP service platform 304 may be routed by a routing node 310. Routing node 310 can include message copy functionality for identifying a message as being associated with a communications service transaction between PC 302 and VoIP service platform 304. If it is determined that the intercepted message is not associated with a communications service transaction, the message is routed to its destination. Otherwise, if it is determined that the intercepted message is associated with a communications service transaction, a portion of the message or the entire message may be copied and the copy forwarded to data acquisition system 128. For example, an IP address and URL identifying PC 302 and VoIP service platform 304, respectively, may be communicated to system 128.

Prepaid service monitoring application 136 may be applied to the data contained in the message copies for analyzing and reporting communications service transactions to a monitoring entity, such as the operator of IP network 300. For example, the communications service transaction information may be used to generate individual transaction detail records (TDRs) for each call associated with a prepaid service provider. Exemplary TDR information may include date, time, calling party ID, prepaid service provider ID, any additional collected/dialed digits, and an originating switching office ID.

It will be appreciated that, in the case of SIP signaling, a prepaid communications service provider may request a SIP URI for input by the subscriber into a PC. This information may be intercepted by routing node 310 for analysis. A prepaid services usage analysis application may analyze such information and provide reports to a service provider of the subscriber.

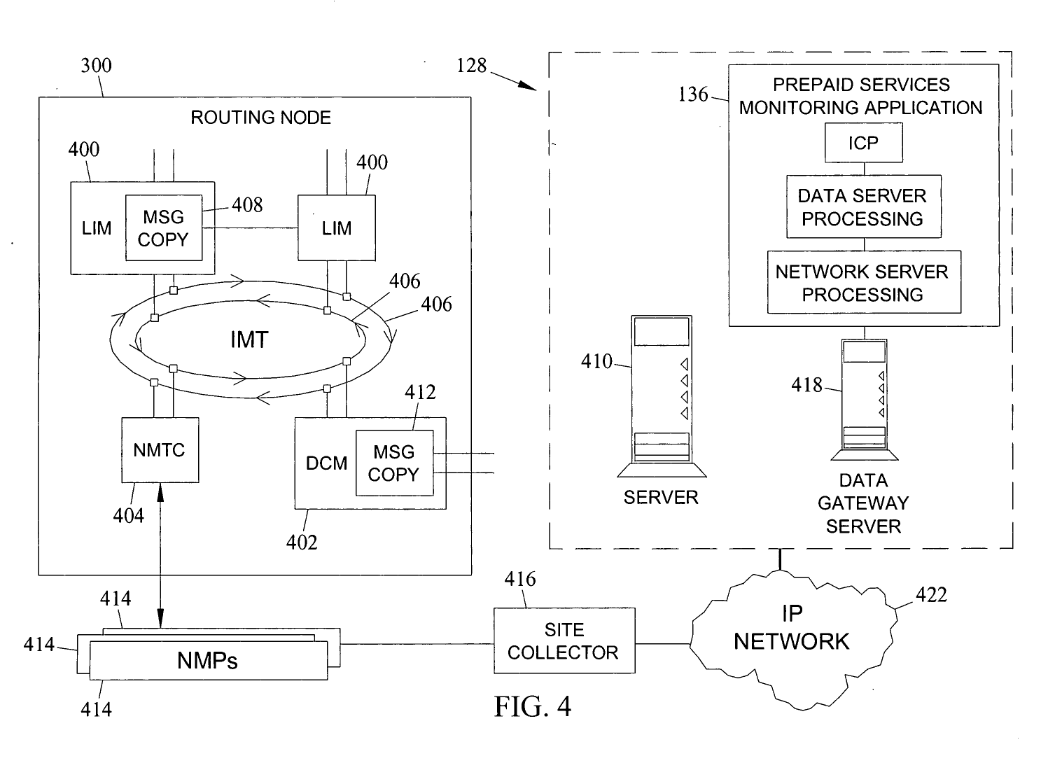

FIG. 4 illustrates an exemplary prepaid communications services monitoring system architecture that is based on the INTEGRATED APPLICATIONS SERVICE™ platform available from Tekelec of Morrisville, N.C. Referring to FIG. 4, routing node 300 is an STP with a plurality of link interface modules (LIMs) 400, a data communications module 402, and a network monitoring transport card 404. Routing node 300 may be located in an SS7 communication link carrying SS7 signaling messages associated with a prepaid communications services. Each module of routing node 300 may include a printed circuit board with an application processor and a communications processor mounted thereon. Modules 400, 402, and 404 are connected to each other via a counter rotating dual ring bus 406. LIMs 400 send and receive SS7 signaling messages over SS7 signaling links and perform MTP3 routing functions.

LIMs 400 may also include message copy functions 408 for copying SS7 signaling messages received over SS7 signaling links and associated with a prepaid service transaction. As stated above, the signaling messages associated with prepaid communications services may be identified by the message's content such as a source address, destination address, a calling party number, and a called party number. A message having an address with an SS7 point code identifying a prepaid communications service provider may be copied. For example, function 408 may copy SS7 IAMs or SS7 SAMs addressed to a prepaid communications service provider. Information for identifying whether a signaling message is associated with a prepaid service transaction may be received from a SENTINEL™ server 410.

DCM 402 sends and receives signaling messages over IP signaling links. Prepaid service functions similar to those described above with respect to function 408 may be incorporated in a message copy function 412 on DCM 402. DCM 402 may include a message copy function 412 for copying signaling messages received over IP signaling links and associated with a prepaid communications service. For example, message copy function 412 may copy SS7 signaling messages sent over IP signaling links or IP telephony signaling messages sent over IP signaling links for network monitoring purposes. A message having an IP address identifying a prepaid service provider may be copied. DCM 402 may receive and internally distribute SIP-based messages related to prepaid communications service in a manner similar to that described above with respect to an SS7 LIM module. For example, DCM 402 may receive SIP INVITE, SIP INFO, and other suitable SIP messages that may be used to facilitate the initial call setup between a calling subscriber and a prepaid communications service provider. Subsequent dialed digit information may be communicated between the calling subscriber and the prepaid service provider using one or more suitable SIP messages.

It will be appreciated that a similar message interception/surveillance scheme can be employed with regard to other types of messaging services, such as multimedia messaging service (MMS) and instant message (IM) service. Depending upon the particular type of messaging service that is to be monitored and the network configuration, the communications service message interception function may be strategically placed at one or more nodes in the network. For example, in a SIP-based network, the subject matter described herein may be implemented on a SIP router, a SIP proxy server, a SIP messaging server, or an IP multimedia subsystem (IMS) network element.

Network monitoring transport card 404 communicates messages or portions of copied messages from signaling links to network monitoring processors (NMPs) 414. When a message copy function 408 or 412 copies signaling messages from a signaling link, the message copy function broadcasts a service request to network monitoring processors 414 via network monitoring transport card 404. In response to the service request, the network monitoring processor provisioned to service the particular copy function establishes a TCP/IP connection with the message copy function via network monitoring transport card 404. The message copy function then sends copied messages to the network monitoring processor over the TCP/IP connection. Network monitoring processors 414 store signaling message copies and forward the copies to a site collector 416. Site collector 416 filters the messages and transmits the messages to a data gateway server 418 via an IP network 420. Data gateway server 418 receives message data from site collector 416. Monitoring application 136 may analyze the collected data and generate call detail records (CDRs) based on the analyzed data. A CDR is a data record containing information related to a communication, such as the origination and destination addresses of the call, the time the call started and ended, and the duration of the call. Server 418 may store or buffer the CDRs.

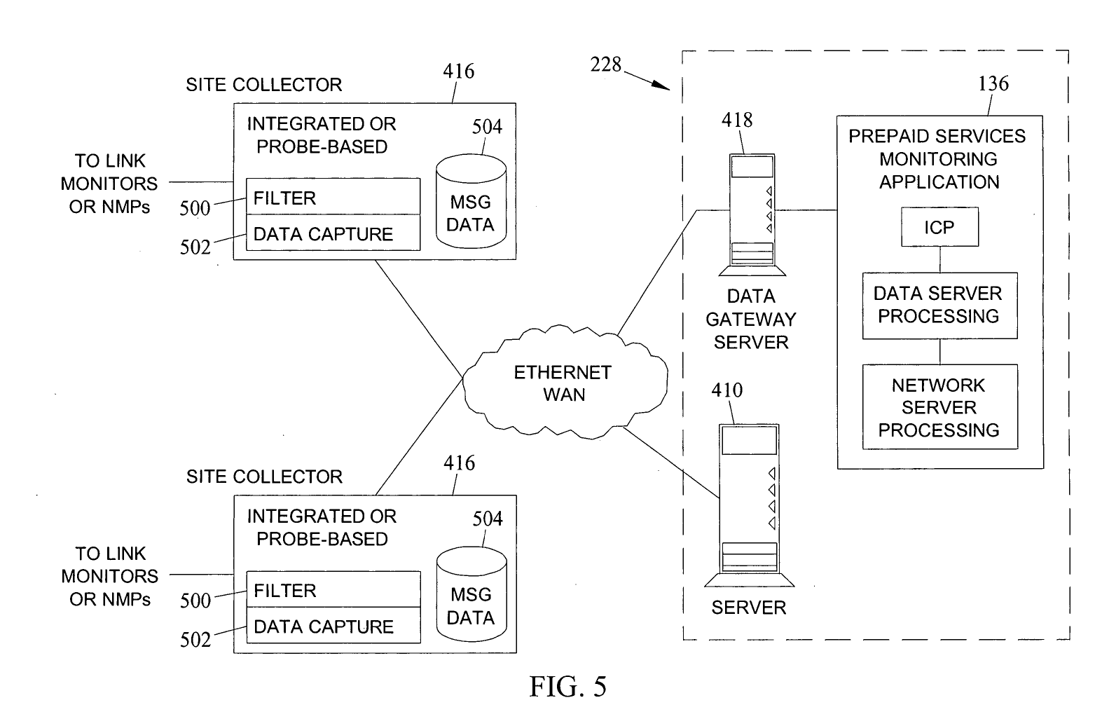

FIG. 5 illustrates a monitoring system architecture that collects signaling information from either discrete communication link probes or from an integrated signal transfer point/signaling gateway message copying interface. Referring to FIG. 5, a pair of site collectors 416 collects and temporarily buffers monitored signaling messages. Site collectors 416 may be connected to external signaling link probes that passively copy signaling messages from SS7 signaling links or to network monitoring processors that receive and store signaling messages copied from signaling links within a routing node, such as an STP.

Each site collector 416 may be a general purpose computing platform including a microprocessor and one or more applications executing thereon. In the illustrated example, each site collector 416 includes a filter application 500, a data capture application 502, and a message database 504. Filter application 500 filters received signaling messages based on filter criteria received from SENTINEL™ server 410. The filter criteria may be structured such that the data captured by site collectors 416 is the superset of data required by prepaid services monitoring application 136 and other network service applications that may be resident on data gateway server 418, or located elsewhere in the network. Received signaling messages may be filtered based on whether they are associated with a prepaid communications services. As stated above, the signaling messages associated with prepaid communications services may be identified by the message's content such as a source address, destination address, a calling party number, and a called party number. A message having an address with an SS7 point code or IP address identifying a prepaid communications service provider may be copied.

Data capture applications 502 capture raw message data copied by the link monitors or NMPs. Message databases 504 store messages captured by data capture applications 502 and filtered by filter applications 500.

Data gateway server 418 receives message data from the site collectors, generates CDRs and TDRs based on the message data, and stores or buffers the CDRs and TDRs. Exemplary reporting information may include date, time, calling party ID, prepaid service provider ID, any additional collected/dialed digits, and an originating switching office ID.

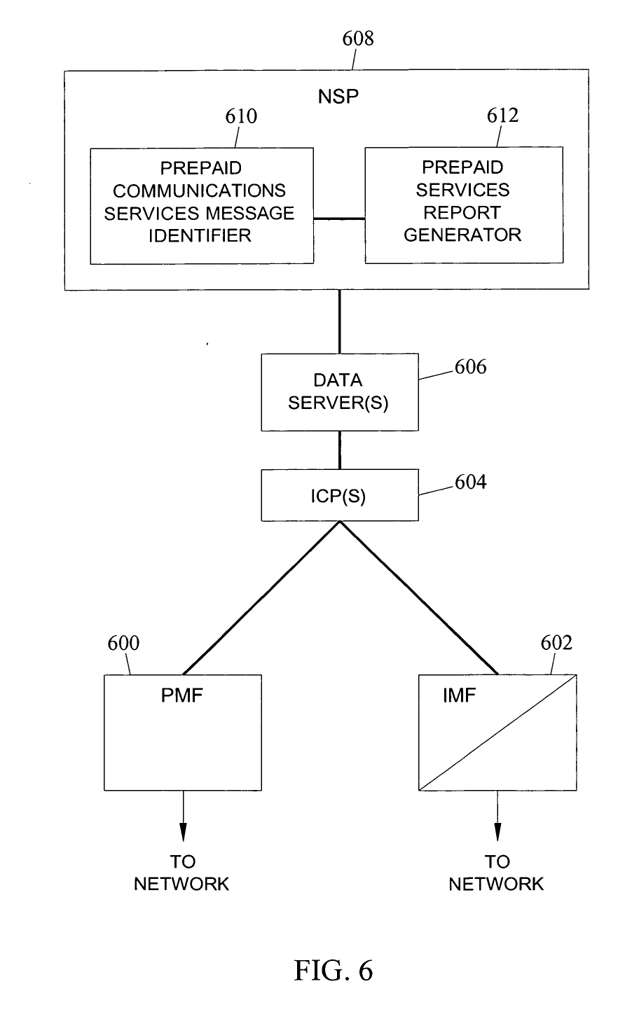

FIG. 6 illustrates a block diagram of an exemplary system architecture for collecting messages associated with providing prepaid communications services in a communications network according to an embodiment of the subject matter described herein. Referring to FIG. 6, the system architecture includes a probe message feeder (PMF) 600 and an integrated message feeder (IMF) 602. PMF 600 may be a probe that is operable to receive signaling message from a signaling link in a communications network. IMF 602 may be STP including functions for receiving signaling message from a signaling link in the communications network. PMF 600 and IMF 602 may copy received signaling messages and forward the copied signaling messages to an integrated CDR platform (ICP) 604. The system architecture may include other probes suitable for copying messages associated with prepaid communications services.

ICP 604 may be operable to receive signaling message copies from multiple PMFs and IMFs. Further, ICP 604 may generate different types of detail records (xDRs) based on the received message copies. For example, ICP 604 may generate a CDR based on ISUP related messages. In another example, ICP 604 may generate an Internet protocol detail record (IPDR) based on IP-related messages, such as SIP-related messages. In yet another example, ICP 604 may generate a signal unit detail record (SUDR) based on signal units. In another example, ICP 604 may generate a TDR based on a transaction protocol. The records may be generated by copying predetermined protocol fields in received messages into a flat file.

The xDRs generated by ICP 604 may be sent to one or more data servers 606 for processing the data contained in the xDRs. For example, ICP 604 may generate information about calls in the communications network, such as Key Performance Indicators (KPIs), Key Quality Indicators (KQIs), alarm data, and statistics.

NSP 608 may receive xDRs, statistics, and alarms from data server 606. NSP 608 may include one or more processors and memory. NSP 608 may include a prepaid communications services message identifier function 110 and a prepaid services report generator 612. Function 610 is operable to receive messages copied from a signaling link in a communication network and identify the messages associated with prepaid calls to a common destination, such as a common geographic region. Generator 612 is operable to generate statistics indicative of the amount of prepaid calls being made to the common destination. For example, generator 612 may be operable to generate a report indicating the amount of calls to a particular destination, the prepaid service provider servicing the calls, and the call duration. The prepaid service provider may be determined by examining the dialed digits contained in the received signaling messages.

It will be understood that various details of the subject matter disclosed herein may be changed without departing from the scope of the disclosed subject matter. Furthermore, the foregoing description is for the purpose of illustration only, and not for the purpose of limitation, as the subject matter disclosed herein is defined by the claims as set forth hereinafter.

What is claimed is:

1. A method for collecting messages associated with providing prepaid communications services in a communications network, the method comprising:
(a) receiving at least a portion of messages copied from a communications network;
(b) identifying the at least a portion of messages as being associated with prepaid calls to a common destination; and
(c) generating at least one measure indicative of an absolute or relative number of prepaid calls being made to the common destination and based on the identified at least a portion of messages.

2. The method of claim 1 wherein identifying the at least a portion of messages as being associated with prepaid calls includes identifying session initiation protocol (SIP) signaling messages associated with prepaid calls to a common destination.

3. The method of claim 1 wherein identifying the at least a portion of messages as being associated with prepaid calls includes identifying signaling system 7 (SS7) signaling messages associated with prepaid calls to the common destination.

4. The method of claim 1 wherein identifying the at least a portion of messages as being associated with prepaid calls includes identifying messages including an identifier associated with a prepaid communications service provider.

5. The method of claim 4 wherein identifying messages including an identifier associated with a prepaid communications service provider includes identifying an identifier selected from the group consisting of a toll free 800 number of a prepaid communications service provider, a premium rate service (PRS) number of a prepaid communications service provider, an SS7 point code of a prepaid communications service provider, an IP address of a prepaid communications service provider, a source address of a prepaid communications service provider, and a destination address of a prepaid communications service provider.

6. The method of claim 1 wherein generating at least one measure includes generating the at least one measure based on contents of the identified at least a portion of messages that identify a common destination.

7. The method of claim 6 wherein generating at least one measure based on contents of the identified at least a portion of messages includes generating the at least one measure based on contents selected from the group consisting of a calling party number, a called party number, an originating switching office identifier, a prepaid service provider identifier, subsequent dialed digit information, a mobile station ISDN number (MSISDN), a mobile identification number (MIN), an international mobile station identifier (IMSI), a directory number, a uniform resource identifier (URI), an IP address, an end office (EO) identifier, an mobile switching center (MSC) identifier, a SIP proxy identifier, a uniform resource locator (URL), an IP address, an SS7 point code address, a toll free number, and a PRS number.

8. The method of claim 6 wherein generating at least one measure based on contents of the identified at least a portion of messages includes generating the at least one measure based on time or date of a communication of the identified at least a portion of messages.

9. A system for collecting messages associated with providing prepaid communications services in a communications network, the system comprising:
(a) a prepaid communications services message identifier configured to receive copies of at least a portion of messages and configured to identify the at least a portion of the messages as being associated with prepaid calls to a common destination; and
(b) a prepaid services report generator configured to generate at least one measure indicative of an absolute or relative number of prepaid calls being made to the common destination and based on the identified at least a portion of messages.

10. The system of claim 9 wherein the prepaid communications services message identifier is configured to identify session initiation protocol (SIP) signaling messages associated with prepaid calls to a common destination.

11. The system of claim 9 wherein the prepaid communications services message identifier is configured to identify signaling system 7 (SS7) signaling messages associated with prepaid calls to the common destination.

12. The system of claim 9 wherein the prepaid communications services message identifier is configured to identify messages including an identifier associated with a prepaid communications service provider.

13. The system of claim 12 wherein prepaid communications services message identifier is configured to identify an identifier selected from the group consisting of a toll free 800 number of a prepaid communications service provider, a premium rate service (PRS) number of a prepaid communications service provider, an SS7 point code of a prepaid communications service provider, an IP address of a prepaid communications service provider, a source address of a prepaid communications service provider, and a destination address of a prepaid communications service provider.

14. The system of claim 12 wherein the prepaid services report generator is configured to generate the at least one measure based on contents of the identified at least a portion of messages that identify a common destination.

15. The system of claim 14 wherein the prepaid services report generator is configured to generate the at least one measure based on contents selected from the group consisting of a calling party number, a called party number, an originating switching office identifier, a prepaid service provider identifier, subsequent dialed digit information, a mobile station ISDN number (MSISDN), a mobile identification number (MIN), an international mobile station identifier (IMSI), a directory number, a uniform resource identifier (URI), an IP address, an end office (EO) identifier, an mobile switching center (MSC) identifier, a SIP proxy identifier, a uniform resource locator (URL), an IP address, an SS7 point code address, a toll free number, and a PRS number.

16. The system of claim 14 wherein the prepaid services report generator is configured to generate the at least one measure based on time or date of a communication of the identified at least a portion of messages.

17. The system of claim 14 wherein the prepaid communications services message identifier and the prepaid services report generator are components of a device selected from the group consisting of signaling transfer point (STP), an SS7 node, an SS7/Internet protocol (IP) router, a SIP router, a SIP proxy server, a SIP messaging server, and an IP multimedia subsystem (IMS) network element.

18. A computer program product comprising computer executable instructions embodied in a computer readable medium for performing steps comprising:
(a) receiving at least a portion of messages copied from a communications network;
(b) identifying the at least a portion of messages as being associated with prepaid calls to a common destination; and
(c) generating at least one measure indicative of an absolute or relative number of prepaid calls being made to the common destination and based on the identified at least a portion of messages.

19. The computer program product of claim 18 wherein identifying the at least a portion of messages as being associated with prepaid calls includes identifying session initiation protocol (SIP) signaling messages associated with prepaid calls to a common destination.

20. The computer program product of claim 18 wherein identifying the at least a portion of messages as being associated with prepaid calls includes identifying signaling system 7 (SS7) signaling messages associated with prepaid calls to the common destination.

21. The computer program product of claim 18 wherein identifying the at least a portion of messages as being associated with prepaid calls includes identifying messages including an identifier associated with a prepaid communications service provider.

22. The computer program product of claim 21 wherein identifying messages including an identifier associated with a prepaid communications service provider includes identifying an identifier selected from the group consisting of a toll free 800 number of a prepaid communications service provider, a premium rate service (PRS) number of a prepaid communications service provider, an SS7 point code of a prepaid communications service provider, an IP address of a prepaid communications service provider, a source address of a prepaid communications service provider, and a destination address of a prepaid communications service provider.

23. The computer program product of claim 18 wherein generating at least one measure includes generating the at least one measure based on contents of the identified at least a portion of messages that identify a common destination.

24. The computer program product of claim 23 wherein generating at least one measure based on contents of the identified at least a portion of messages includes generating the at least one measure based on contents selected from the group consisting of a calling party number, a called party number, an originating switching office identifier, a prepaid service provider identifier, subsequent dialed digit information, a mobile station ISDN number (MSISDN), a mobile identification number (MIN), an international mobile station identifier (IMSI), a directory number, a uniform resource identifier (URI), an IP address, an end office (EO) identifier, an mobile switching center (MSC) identifier, a SIP proxy identifier, a uniform resource locator (URL), an IP address, an SS7 point code address, a toll free number, and a PRS number.

25. The computer program product of claim 23 wherein generating at least one measure based on contents of the identified at least a portion of messages includes generating the at least one measure based on time or date of a communication of the identified at least a portion of messages.
